(19) United States
(12) Patent Application Publication
(10) Pub. No.: US 2022/0168844 A1
(43) Pub. Date: Jun. 2, 2022

(54) METHOD AND APPARATUS FOR MANUFACTURING FINNED TUBES

(71) Applicant: Schmöle GmbH, Fröndenberg (DE)

(72) Inventor: Till NEUMANN, Iserlohn (DE)

(21) Appl. No.: 17/536,534

(22) Filed: Nov. 29, 2021

(30) Foreign Application Priority Data
Nov. 27, 2020 (DE) 10 2020 131 560.0

(51) Int. Cl. B23K 26/302; B23K 26/08; B23K 26/067; F28F 1/36

(52) U.S. Cl. CPC B23K 26/302; B23K 26/083; G02B 6/10; F28F 1/36; B23K 26/067

(57) ABSTRACT

A method for producing ribbed pipes, in which a first pipe base body is ribbed on its outer side, in particular helically, with a first band, to which end the first band is secured to the first pipe base body using a first laser beam. While the first band is being secured to the first pipe base body using the first laser beam, a second pipe base body is ribbed on its outer side with a second band, to which end the second band is secured to the second pipe base body using a second laser beam, wherein the first and second laser beams come from the same laser source.

The invention relates firstly to a method for producing ribbed pipes, which typically consist of a round-pipe base body in the form of a round pipe which, in order to improve the heat transfer properties, is ribbed, preferably helically, with a band. Such ribbed pipes are used in heat exchangers and are typically flowed through by a fluid, for example heated water. The ribbed pipes used in such heat exchangers can themselves have a helical form.

Methods for producing such ribbed pipes are well known in the prior art. Typically, the band is welded to the pipe base body by means of a laser.

In the prior art, efforts are constantly being made to reduce the costs of producing such ribbed pipes.

Such efforts typically result in attempts being made to optimise the pipe or band material or the ribbing speed, but in practice this is found to be fundamentally difficult.

Accordingly, it is an object of the present invention to enable even more economical production of ribbed pipes.

The present invention achieves this object according to a first aspect with a method according to patent claim 1 and is therefore characterised in particular in that, while the first band is being secured to the first pipe base body using the first laser beam, a second pipe base body is ribbed on its outer side with a second band, to which end the second band is secured to the second pipe base body using a second laser beam, wherein the first and second laser beams come from the same laser source.

In other words, the idea of the invention consists in using a single laser source for ribbing multiple pipe base bodies.

To put it yet another way, the energy of the laser source is “split” between at least two pipe base bodies which are to be ribbed.

Accordingly, the simultaneous production of multiple finished ribbed pipes is possible using only one laser source, whereby the production times are reduced significantly and in particular only the operating costs of one laser source, that is to say of one laser, are to be paid.

Furthermore, only one cooling means for the laser source is necessary and thus not multiple cooling means for multiple independent lasers which are to be operated.

This is associated with a considerable cost saving.

The invention accordingly allows multiple ribbed pipes to be produced simultaneously, even though only one laser source is present.

The costs for producing a predefined quantity of ribbed pipes can thus be reduced significantly.

Within the context of the application, the method, or the apparatus according to the invention, thus has at least one laser source and this at least one laser source serves to generate at least two laser beams.

In principle, more than two, for example three, four or even more, laser beams can of course also be provided according to the invention.

Each of the at least two laser beams serves to secure a band to different pipe base bodies.

In this context, when more than two laser beams are provided, more than two pipe base bodies can also be provided, wherein exactly one laser beam is then associated with each of the pipe base bodies to be ribbed.

For example, it is thus possible to provide three pipe base bodies and three laser beams, which come from the same laser source.

According to the preferred exemplary embodiment, however, exactly two laser beams, which come from the same laser source, are provided.

The laser can in particular be a fibre laser (or a CO₂ laser or a laser with blue or green light).

The laser can preferably have a power of at least 2 KW, in particular of at least 3.5 KW, more preferably of at least 4 KW.

The power provided by a laser can in particular be split evenly between the laser beams that are generated (thus, where there are two laser beams, in particular 50-50).

Suitable means can be used for splitting the laser power into different beams. In particular, the laser, or the apparatus according to the invention, can have a so-called beam splitter.

Any suitable beam splitter can be used as the beam splitter. Depending on the characteristic, beam-splitter plates or beam-splitter cubes or prisms, for example, can be used.

If other means are suitable, these can of course be provided as an alternative or in addition, such as, for example, beam-splitter mirrors.

Depending on their suitability, the beam splitters can be non-polarising or non-polarised or polarising beam splitters.

A suitable beam splitter can thus be part of the apparatus according to the invention.

Two or more laser outlets can be associated with the laser source. The laser source can either have the laser outlets or be connected to the laser outlets, for example via flexible lines.

In particular, beam waveguides, for example glass fibre cables or the like, can be provided for connecting the laser outlets to the laser source.

However, all other ways of connecting laser outlets to a laser source or of integrating laser outlets into the laser source are of course included in the invention.

In the method according to the invention, at least two separate pipe base bodies are ribbed by means of the at least two laser beams.

The pipe base bodies can in particular be of the same type, that is to say, for example, have the same material properties and/or the same dimensions (such as, for example, the same diameter and/or the same wall thickness and/or the like). They can in particular be cut from the same pipe base body.

It should be noted in this context that, in the method according to the invention, either identical ribbed pipes (with identical pipe base bodies and ribs) or different ribbed pipes (with different pipe base bodies and/or ribs) can be produced using (simultaneously) the first and second laser beams. The invention includes both possibilities: Thus, for example, the first laser beam can secure ribs of a first type to a pipe base body of a first type and the second laser beam can secure ribs of a second type to a second pipe base body, wherein the pipe base bodies and/or the ribs can be different.

The at least two pipe base bodies are each ribbed with a band in the method according to the invention. The bands which are associated with the separate pipe base bodies are typically separate bands.

These bands can come from a common band supply (for example a common reel or a common roll, coil or the like). It is, however, likewise possible according to the invention that the bands are provided from completely separate supplies.

For attaching the bands to a pipe base body, band feeds are typically used.

Each of the pipe base bodies can be associated with its own, that is to say separate, device for feeding the band. Theoretically, however, it can also be possible that a common device for feeding band material is associated with the pipe base bodies. What is important is that there is associated with each pipe base body a separate laser beam, which come from the same laser source.

Although it is advantageous in principle that exactly one laser beam is associated with each pipe base body, the invention naturally also includes the case where not only one laser beam but a plurality of laser beams is associated with each pipe base body. This can serve, for example, to rib a pipe base body, in particular simultaneously, with two bands.

Within the context of the main claim of the present patent application, it is in particular possible also to provide a third laser beam which secures a third band to one of the two pipe base bodies (and a fourth laser beam which secures a fourth band to the other pipe base body).

While the laser beam is typically fixed, that is to say acts stationarily on a pipe base body, and the band is also typically supplied to the pipe base body via a fixed (possibly adjustable) band feed point, the pipe base body is usually arranged so as to be displaceable.

Typically, the pipe base body is conveyed linearly, in the axial direction, while it is being ribbed, that is to say while a band is being fed thereto and a laser beam acts thereon.

As a result of the linear displacement movement in combination with a rotation, the typical helical arrangement of the attached band is then formed on the outer side of the pipe base body.

The pipe base body is in particular displaced relative to the band feed or to the laser beam and/or the laser outlet (this applies to both pipe base bodies of the at least two pipe base bodies). Preferably, the pipe base body is also displaced absolutely relative to these elements, that is to say it is moved.

In principle, however, a (linear) relative movement between the pipe base body and the band feed and/or laser beams and/or laser outlet can also be effected according to the invention in that the pipe base body is (linearly) fixed and the band feed (optionally together with the band supply) and/or the laser beam or laser outlet is associated with a (linearly) displaceable carriage or the like.

On attachment of the bands to the respective pipe base bodies, the laser beams typically irradiate the contact region of the pipe base body and the band, wherein during welding preferably both pipe base body material associated with the contact region and band material associated with the contact region is irradiated by the laser beam in question and melted.

The attachment of the bands to the at least two pipe base bodies takes place in particular substantially simultaneously, which makes possible the above-described time saving according to the invention.

The bands are preferably arranged in parallel on the respective pipe base body, preferably such that they surround the pipe base body helically.

In particular, the bands attached to the two pipe base bodies have the same pitch. The pitch of a pipe base body can be a constant pitch or a changing pitch.

According to an advantageous embodiment of the invention, all the bands consist of the same material, in particular come from the same band source. For example, each of the bands can be provided using a stainless steel split band which can be cut from the same roll for multiple bands.

Accordingly, the bands thus preferably also have the same width, or subsequent rib height.

Further preferably, the bands consist of stainless steel. In principle, however, the invention also includes bands which consist of copper or aluminium or another material.

Although it is advantageous that the bands of the different pipe base bodies consist of the same material, this does not exclude the idea of using bands of different materials and/or different heights and/or different thicknesses and/or different shapes for ribbing the first and second pipe base bodies (in the sense that the first pipe base body is ribbed with a band of a different type to the second pipe base body).

Typically, the band material is in each case in an endless form (for example a roll or the like) and is supplied to the pipe base body, which is typically suspended so as to rotate.

The pipe base bodies can carry the bands with them during the ribbing process such that the bands are applied substantially helically to the respective pipe base body, in particular under tension, and are there welded by the respective laser beam.

Once the weld seams are complete, the ribbed pipes which have been produced can then be converted into a final form, for example the form of a coil or also a Q form.

The first and second laser beams can irradiate the respective contact region in such a manner that the bands are secured and welded circumferentially to the pipe base body at an edge, in particular with a bottom narrow side (in the case of the example of a rectangular cross-section). The bands can typically be bands which are homogeneous throughout and do not have breaks.

The pipe base bodies are substantially round pipes of a desired length, which are typically in a straight form during the ribbing process. During the ribbing process, the pipe base bodies can in particular rotate, to which end they can be clamped at their ends or applied to a mandrel. As already described, they are naturally displaced in the axial direction during ribbing.

It should again be noted that the first and second pipe base bodies can in principle come from the same base pipe. For example, they can be cut from the same base pipe, wherein two portions of the base pipe then serve as the first and second pipe base bodies.

For the purpose of ribbing, the bands can typically be supplied to the respective pipe base body transversely to the direction of the longitudinal extent of the pipe base bodies (that is to say tangentially).

According to a further advantageous embodiment of the invention, the bands are strip-like, that is to say are initially in the form of a strip.

It is further advantageous if their cross-section is I-shaped, that is to say forms substantially a rectangular shape. The strip has such an I-shape in contrast to a U-shape or an L-shape. A form of a rib that is I-shaped in cross-section offers the advantage of optimum heat conduction and makes it possible to use less rib material. Alternatively, however, a different shape (also one of the mentioned shapes) can be provided.

It can also be provided that there is fed to each of the irradiated contact regions a cooling gas (or also a common cooling gas from a common source). Although the feeding of a gas is well known from the prior art, such a gas serves substantially as a protecting gas in hitherto existing band materials and is intended to prevent corrosion. According to the invention, a cooling gas can even be used in the present case.

According to the most preferred embodiment of the invention, the bands are in contact with the respective pipe base bodies over a substantially equal circumferential angle prior to irradiation by the respective laser beam. Accordingly, if the first band on the first pipe base body is carried along by the rotating pipe base body over an angle of 30°, for example, before it is subjected to the first laser beam, the second band on the second pipe base body can also be carried along by the rotating second pipe base body over a corresponding angle of about 30° before it is subjected to the second laser beam.

The bands are thereby preferably under tension, that is to say are carried along by the rotating pipe base bodies.

The pipe base bodies can typically consist of copper, aluminium or another suitable metal (in particular stainless steel). The ribs can consist of the same material or of another suitable material (for example stainless steel, copper, aluminium, titanium or the like).

According to a particularly advantageous embodiment of the invention, the pipe base bodies are displaced or driven at substantially the same speed. This permits maximum speed utilisation.

In another advantageous embodiment of the invention, the pipe base bodies are displaced or driven at different speeds. A corresponding apparatus in particular allows the conveying speeds of the two pipe base bodies to be adjusted independently.

In the case where the two pipe base bodies are displaced at different speeds, the distribution of the energy of the laser source to the two corresponding laser beams can preferably be adjusted (in particular such that the energy is not split equally but more energy is allocated to the laser beam that is associated with the pipe base body with the higher speed than to the other laser beam).

The pipe base bodies can in particular be provided in a type of holder or the like, which is configured as a transport device or conveying device for moving the pipe base bodies, in particular linearly.

The pipe base bodies can advantageously be stopped independently of one another. They are thus able to be stopped independently of one another. This in particular allows the band material to be changed independently, for example if the band material for one pipe base body has been used up and band material must be provided from a new source or the like. The conveying devices for the respective pipe base bodies can thus be stopped independently of one another in the sense that one can be stopped while the other continues to convey.

According to a further particularly advantageous embodiment of the invention, the outlets for the two laser beams are arranged substantially between the pipe base bodies. This permits a particularly effective geometry of the apparatus for ribbing pipes as a whole.

In this context, a laser source can then in particular (also) be arranged substantially between the pipe base bodies.

Within the context of the present patent application, substantially “between” means that the outlets and/or the laser source are arranged in a region between the pipe base bodies. They can, however, also overlap the plane of the pipe base bodies.

According to a further advantageous embodiment of the invention, the at least two bands can be supplied to the respective pipe base body and fitted thereto using in each case a guide element.

The guide element is in particular the transfer point of a band feed to the respective pipe base body, wherein this guide element is typically fixedly positionable (in particular can also be configured to be adjustable), while the corresponding pipe base body typically rotates and moves about its own axis. Each pipe base body thus has its own associated guide element.

In principle, however, the invention can also include exemplary embodiments in which a common guide element (which can handle multiple bands) is associated with the different pipe base bodies.

The present invention relates further to an apparatus for producing ribbed pipes which in particular can carry out a method according to the invention.

In this context, the invention achieves the stated object according to this further aspect with an apparatus according to patent claim 6, which is characterised in particular by a second laser outlet, associated with the laser source, for providing a second laser beam for securing a second band to a second pipe base body.

It should be noted at this point that all the advantages and embodiments of the method according to the invention described hereinbefore can of course also be applied to the apparatus according to the invention according to patent claim 6 (at least provided that no conflicts occur). Merely for reasons of clarity of the application, these advantages will not be repeated in their entirety at this point in relation to the apparatus but are to be considered disclosed also in relation to the apparatus.

The same is of course also to apply conversely. Thus, all the advantages and embodiments which are described hereinbelow in relation to the apparatus according to the invention are to be considered disclosed for the method according to the invention which has already substantially been described.

In this context, the apparatus according to the invention can displace or drive the first and second pipe base bodies, preferably linearly and/or substantially at the same speed, in particular relative to the laser source and/or the laser beams.

In the apparatus too, the outlets for the two laser beams and/or the laser source can be arranged substantially between the pipe base bodies, in particular between holders associated with the pipe base bodies.

However, this list is to be understood merely by way of example and not as being exhaustive.

According to a particularly preferred embodiment of the apparatus according to the invention, the apparatus has a first holder for the first pipe base body and a second holder for the second pipe base body. These holders can be in the form of conveying devices and displace or convey the pipe base bodies, preferably linearly, for the purpose of ribbing.

In particular, the holders can be formed completely separately from one another or can be in the form of holders of a common holding device, which has, for example, a first holding portion for holding the first pipe base body and a second holding portion for holding a second pipe base body.

The holders can in particular be in the form of carriages or the like.

They can in particular be displaceable relative to the holding device and/or preferably relative to the laser outlets and/or the laser source.

The first laser outlet is preferably associated with the first holder and the second laser outlet with the second holder. This in particular such that the first laser outlet is directed at the first holder and the second laser outlet at the second holder.

In this context, the laser outlets thus each point at or are directed at the different holders, at least when they are not in the moved state.

During ribbing, the holders can be displaced in the manner of carriages. The two laser outlets each point at part of the moving holders, namely at the part in which the portion of the respective pipe base body that is to be ribbed is situated.

The two laser outlets are preferably connected to the laser source via flexible lines, which permits particularly high flexibility in terms of the configuration of the apparatus according to the invention. The laser outlets can thereby be directed and/or are directed at the pipe base bodies.

Finally, it is provided according to the invention that the laser source of the apparatus according to the invention has a power of at least 2 KW, preferably of at least 3.5 KW or even of at least 4 KW or even more.

In this context, the laser source can split its power between the individual laser outlets or between the individual laser beams emitted from the laser outlets, preferably equally. In this context, it can be provided, for example in the case of a laser source having a power of about 4 KW, that each of the two laser outlets provided provides a laser beam with a power of 2 KW.

Further advantages of the invention will become apparent from the dependent claims, optionally not cited, and from the description of the figures given hereinbelow.

In the figures:

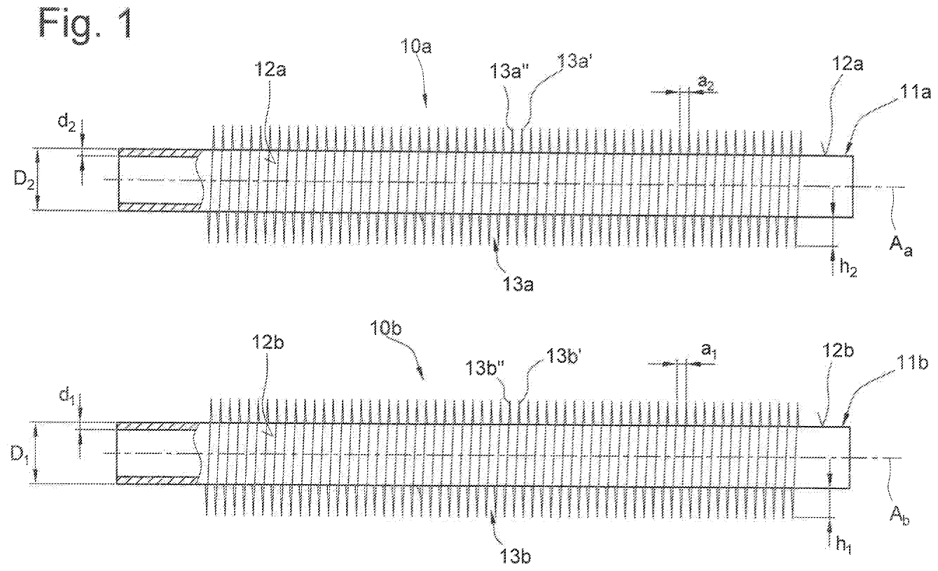

FIG. 1 shows, in a highly schematic, partially cutaway side view, two ribbed pipes produced, in particular produced substantially simultaneously, in a method according to the invention or using an apparatus according to the invention,

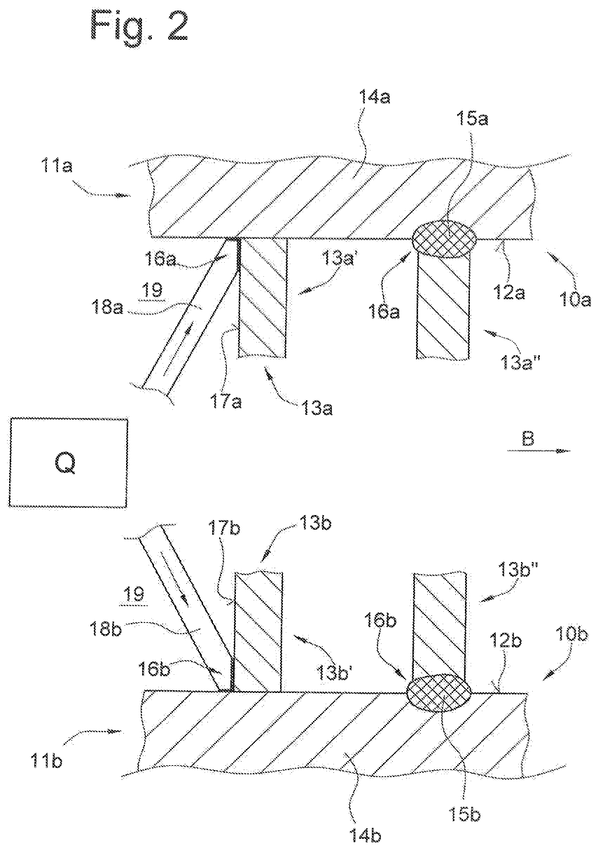

FIG. 2 shows, in a truncated sectional side view, in each case a region of the ribbed pipes according to FIG. 1, in a highly enlarged schematic illustration during the process of securing the bands, using two laser beams, the beam outlets, not shown, of which are associated with a common source,

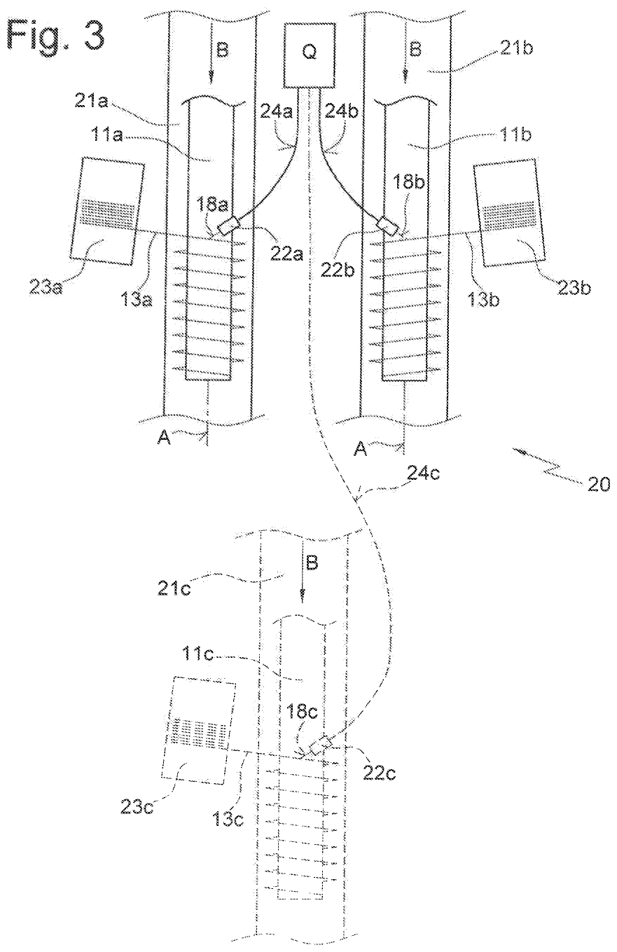

FIG. 3 shows, in a schematic top view, parts of the apparatus according to the invention while carrying out a method according to the invention during ribbing of the two pipe base bodies, with a further pipe base body shown by a broken line and the components required therefor likewise shown by a broken line,

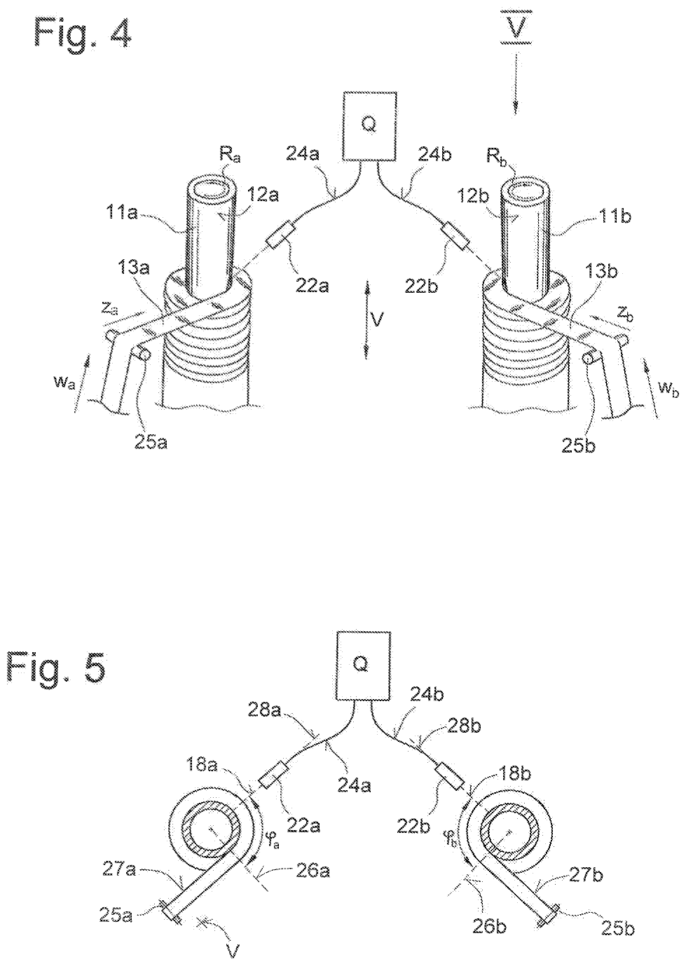

FIG. 4 is a highly schematic, perspective (bottom) view of the process of winding two bands in each case on a rotating pipe base body,

FIG. 5 shows, in a highly schematic view, approximately according to view arrow V in FIG. 4, a front, cutaway view of the pipe base bodies together with the bands and the adumbrated laser beam outlets,

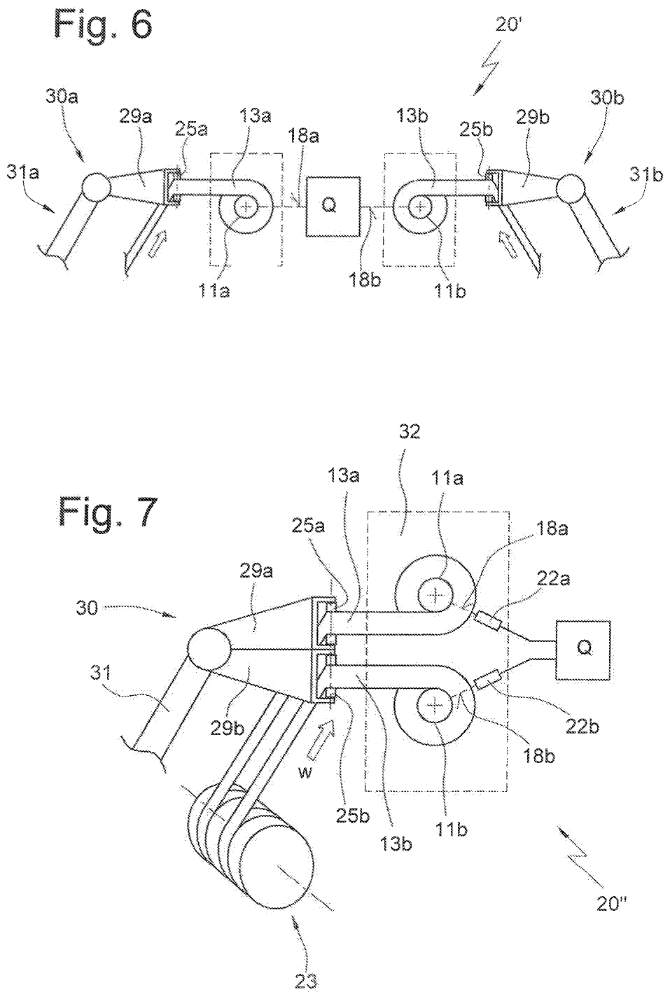

FIG. 6 shows, in a highly schematic side view, approximately in a view according to FIG. 5, an exemplary embodiment with guide elements arranged on robotic arms during the process of ribbing two pipe base bodies, and

FIG. 7 shows, in a view approximately according to FIG. 6, an alternative exemplary embodiment in which it is shown that the bands come from a common band supply and in which the two feed elements are associated with one another, for example are arranged on the same robotic arm.

Exemplary embodiments of the invention are described by way of example in the following description of the figures, also with reference to the drawings. For the sake of clarity—and also inasmuch as different exemplary embodiments are concerned—identical or comparable parts or elements or regions are denoted by identical reference numerals, in some cases with the addition of lowercase letters or apostrophes.

Features that are described only with reference to one exemplary embodiment can also be provided within the scope of the invention in any other exemplary embodiment of the invention. Such modified exemplary embodiments are included in the invention—even if they are not illustrated in the drawings.

All the disclosed features are per se essential to the invention. The disclosure of the associated priority documents (copy of the preliminary application) and of the cited publications and of the described apparatuses of the prior art are hereby incorporated in their entirety in the disclosure of the application, also for the purpose of including individual or multiple features of these documents in one or in multiple claims of the present application.

FIG. 1 first shows two ribbed pipes 10a and 10b, which have been produced (simultaneously) in a method according to the invention using an apparatus according to the invention.

It can clearly be seen that the ribbed pipes 10 each consist of a pipe base body 11 which is ribbed with a band 13 on its outer side 12. Although the bands 13 are each continuous, the individual portions of the band that are visible in the figure are denoted ribs 13′ and 13″ for the sake of simplicity. The spacing between two ribs is denoted a in FIG. 1, the height of the ribs (that is to say the height of the respective band 13) is denoted h, the diameter of the pipe is denoted D and the wall thickness of the pipe base body 11 is denoted d.

In the exemplary embodiment shown, the two pipes 10a, 10b are substantially identical, that is to say they have substantially the same rib height h, the same pipe diameter D, the same wall thickness d and the same rib spacing a.

However, this is to be understood merely as an example. In particular, two different ribbed pipes with d₁≠d₂ and/or D₁≠D₂ and/or h₁≠h₂ and/or a₁≠a₂ can also be produced in a method according to the invention using an apparatus according to the invention.

In the exemplary embodiment according to FIG. 1, in particular the rib spacing a for the two ribbed pipes 10 is constant. That is to say, a constant rib pitch is present for each of the ribbed pipes 10.

However, in other exemplary embodiments, the ribbed pipes could equally be ribbed pipes with a varying rib pitch. In particular, it is even possible in a method according to the invention to produce two ribbed pipes with different rib pitches and/or a rib pitch which changes differently, that is to say, for example, a first ribbed pipe with a constant rib pitch and a second ribbed pipe with a changing rib pitch.

Ribbed pipes as shown in FIG. 1 are known in principle. However, in the prior art they are produced by a different method, namely, for example, in succession in one apparatus or in two apparatuses each having a laser or a laser source.

FIG. 2 shows, in a highly schematic sectional view, in each case an enlarged region on the outer side 12 of the two pipe base bodies 11a and 11b. The pipe wall is provided with the reference numeral 14 and is shown truncated, the hollow region in the middle of each pipe is not shown for reasons of clarity.

FIG. 2 shows in particular the process of laser welding, that is to say of attaching the two bands 13a and 13b to the respective pipe base body 11a or 11b (or the respective outer side 12 thereof).

To this end, the pipe base bodies 11 are moved in rotation in a movement direction B, namely along their respective longitudinal axis A, and the bands 13a and 13b are thereby welded continuously.

FIG. 2 shows in its upper region, which concerns the first pipe base body 11a, first the rib 13a″ in the already welded state. The already solidified melt 15 in the contact region 16 between the respective pipe base body 11 and the respective band 13 can be seen in FIG. 2. The melt 15 consists partially of material of both the corresponding pipe base body 11 and the corresponding band 13, or rib 13′ (on the underside thereof). To this end, the ribs 13 are depicted approximately rectangularly in cross-section.

The rib 13a″ shown on the right in FIG. 3 (as a rib which has already been attached) is further ahead in the movement or ribbing direction B than a rib 13a′ of the same band 13a also shown in FIG. 3. In FIG. 3, this rib 13a′ of the band 13a is in the process of being welded in the contact region 16a (which, owing to the linear-straight pipe surface or outer side 12a and the straight side edge 17a of the rib 13a′ is substantially L-shaped).

To this end, a first laser beam 18a, for example a fibre laser beam, strikes the contact region 16a at a predefined angle. The laser beam 18a thereby irradiates both the material of the band 13a, or of the rib 13a′, and the material of the pipe base body 11a, in particular at the surface 12a thereof.

Simultaneously with the attachment of the band 13a by means of the first laser beam 18a, another band 13b is secured to the second pipe base body 11b, namely by means of a second laser beam 18b. To this end, the laser beam 18b, by way of example in the exemplary embodiment shown, irradiates the outer side 12b of the pipe base body 11b, in particular in the region of the rib 13b′. This laser beam 18b also irradiates both material of the band 13b, or of the rib 13b′, and material of the pipe base body 11b, namely in a contact region 16b (which is likewise substantially L-shaped). The material is melted and the melt 15b already described above is then formed, which is shown by way of example in FIG. 3 in respect of the rib 13b″ of the band 13b.

In this respect, the rib 13b′ is behind the rib 13″ in the ribbing direction and represents, as it were, the state of welding, while the rib 13b″ illustrates the already finished, welded-on state of a rib, or of a portion of the band 13b. Further portions of the band 13b, or further ribs of the band 13b, can of course follow with a defined spacing in the ribbing direction B (and thus already be welded).

The same of course applies also to the first band 13a, or the first pipe base body 11a.

It should in principle be noted at this point that reference is made in the figures, merely for the purposes of the illustration, to the individual ribs 13a′, 13a″, 13b′ and 13b″. However, these are naturally not individual bodies but portions, or parts, of the band 13a or band 13b which only appear to be separate in the cross-sectional view according to FIG. 2.

Finally with regard to FIG. 2, it should be noted that this figure shows that the laser beams 18 are oriented substantially in the movement direction B, that is to say radiate in the ribbing direction B. This relates in each case to a directional component of the laser beams 18. The laser beams thus radiate, as it were, away from the free region 19.

It is also very important in FIG. 2 that the two laser beams 18 are shown truncated in the figure. However, they both go back to the same laser source Q. The two laser beams are thus generated by the same laser Q. How they can come from the same source but radiate in different radiation directions will be discussed in greater detail later in relation to the other figures.

FIG. 3 thus shows, in a highly schematic top view, an apparatus 20 according to the invention which comprises both a single laser source Q and two holders 21, one for each of the two pipe base bodies 11a and 11b shown.

The holders 21 can provide means for clamping the pipe base bodies 11a and 11 b and rotating them about their longitudinal axes A.

In particular, the holders 21 are in the form of conveying devices, since they are capable of moving the pipe base bodies 11, which are shown truncated in FIG. 3, linearly in the displacement direction B.

This displacement of the pipe base bodies 11 takes place in particular relative to the laser source Q and to a laser outlet 22 connected to the laser source Q and/or to a feed, not shown in the figures, for the respective band 13a or 13b.

According to FIG. 3, the laser outlet 22a provides the laser beam 18a by means of which the band 13a is welded to the pipe base body 11a.

Similarly, the laser outlet 22b provides the laser beam 18b by means of which the band 13b is welded to the pipe base body 11b.

The respective bands 13 come from band supplies 23, which are merely adumbrated in FIG. 3 and can be, for example, in the form of reels, coils, spools or the like. The relative movement of the pipe base bodies 11 takes place in particular also relative to the band supplies 23.

In the exemplary embodiment shown, these band supplies 23 are completely separate.

According to FIG. 3, the laser outlets 22 are connected to the laser source Q via lines 24. The lines 24 can be light cables, for example light waveguides, in particular glass fibre cables or the like. These lines 24 are in particular flexible and thus allow the laser outlets 22 to be directed at the respective pipe base body 11, or the respective band feed, not shown, and/or holder 25.

In the exemplary embodiment shown, the laser of the laser source Q can split its energy (of, for example, 4 KW) between two laser outlets 22a and 22b and thus generate two laser beams 18a and 18b, which in particular are of substantially equal intensity. These laser beams are then used to rib two wholly autonomous or independent pipe base bodies 11a and 11b with band material.

Depending on the intensity of the laser and the demand made of the laser beam, it is, however, also possible in principle to rib more than two pipe base bodies 11a and 11b using a single laser source Q, namely, for example, a further pipe base body 11c or even further pipe base bodies.

Such a further pipe base body 11c is illustrated by a broken line in FIG. 3, as is a corresponding holder 21c and a further band 13c, or a band supply 23c. The band 13c can thereby be secured to the pipe base body 11c as described in relation to the other two pipe base bodies, namely by means of a further laser beam 18c which is provided from a laser outlet 22c which is likewise connected to the laser source Q via the line 24.

The illustration by a broken line is intended to show that the invention is not limited to an exemplary embodiment with two pipe base bodies that are to be ribbed simultaneously, wherein a laser source Q, depending on its power, can or could readily generate more than two laser beams 18.

FIG. 4 illustrates, in a perspective but likewise schematic view, the winding or ribbing of the pipe base bodies 11a and 11b with the bands 13a and 13b. It is apparent from FIG. 4 that the bands 13a, 13b are ultimately fed in a straight line, substantially in feed directions Z, to the pipe base bodies 11 and then contact the pipe base bodies tangentially at their surface 12.

However, before the bands 13 are guided in the feed direction Z, they first run, as is apparent from FIG. 4, in a different unwinding direction W. They are thereby each deflected, namely from direction W into direction Z, by a guide element 25 in the form of a roller.

The guide elements 25 according to FIGS. 4 and 5 are by way of example in the form of deflecting rollers. These guide elements 25 are therefore typically components of a guide device, otherwise not shown, for the respective band 13.

The guide elements 25 can in particular be adjustable, in the exemplary embodiment according to FIG. 5, for example, in an adjustment direction V, in particular a linear adjustment direction.

This adjustability of the guide elements 25 in the adjustment direction V allows an adaptation to be made to the change in the speed of displacement of the respective pipe bodies 11 in the axial direction A (or movement direction B) and/or rotation direction R.

Merely for the sake of completeness, it is noted that a corresponding guide device actually has more than only one deflecting element in practice, in order to allow the band purposively to be fed from a supply (or a coil) to the respective pipe base body 11.

The pipe base bodies 11 are clamped—although this is not shown here—in order to be driven in a rotating manner in the respective rotation direction R and axially in the axial direction A (or movement direction B). The pipe base bodies 11, while being driven in this manner, can pull their respective band 13a or 13b with them and remove it, for example, from a supply roll or a reel or a bed, in a targeted manner and with the application of a defined tensile and braking force. In addition, a drive for the supply, in particular the supply rolls (for example a spool drive), can also be provided.

As a result of these tensile forces and a feed motion of the respective band 13 which may optionally be present, the bands 13a, 13b are applied continuously and progressively to the respective surface 12 of the pipe base bodies 11. The application begins, as shown in FIG. 5, approximately in a region which is identified with a radial axis 26 there.

From this region, the bands 13 thus lie with their respective underside 27 in contact with the respective upper side 12 of the pipe base bodies 11. As a result of the rotation movement in the respective rotation direction R, the bands 13 then run, in contact with the surfaces 12 of the pipe base bodies 11, over an angle range co with the respective pipe base body 11 before, in the region of a radial axis denoted 28, they are each welded by a laser beam 18 to the respective pipe base body 11.

The laser beams are emitted from the laser outlets 22, which are connected to the common laser source Q via light cables 24. The flexible lines 24 permit ideal adjustment to the contact region 16 to be irradiated.

While the guide elements 25 shown according to FIGS. 4 and 5 are guide elements in the form of deflecting rollers, other forms of a guide element according to the invention are of course also possible: for example, guide elements without moving parts, which are in the form of, for example, bodies which are approximately fork-shaped in cross-section or which provide a connecting member for guiding the band.

FIG. 6 shows an alternative embodiment of the apparatus 20′ according to the invention. The guide elements 25 (with or without a deflecting roller), which are not shown in greater detail, are here each arranged at the end of a limb 29 of a robotic arm 30. This robotic arm 30 can be a typical robotic arm, as is known from robotics or robot automation. In particular, hinge points can be provided between individual limbs (29 and 31 in the exemplary embodiment). Additional joints can likewise also be provided at the end of the terminal limb 29, that is to say, for example, substantially in the region of the guide elements (not explicitly shown).

The arrangement of the guide elements 25 on optional robotic arms thereby permits/facilitates the production of the ribbed pipes according to the invention. In particular, an adjustment can take place during ribbing, namely, for example, in the case where a change of speed (rotational or in the axial direction) of the pipe base bodies 11 to be ribbed takes place in order to achieve a change in the rib pitch.

Incidentally, no holders or clamping devices for the pipe base body 11 are shown in FIG. 6. Such equipment is merely adumbrated by a box shown by a broken line.

The robotic arms 30 have further advantages, namely, for example, that, in the case of a break in production or the like, the guide elements 25, for example for maintenance purposes, can be moved away out of the region in front of the transition point of the bands 13 to the respective pipe base body 11 (the robotic arms 30 can consequently be pivoted for this purpose), simultaneously and wholly independently of one another.

In the exemplary embodiment according to FIG. 6, the two laser beams 18a, 18b are associated with the source Q only schematically. This shows that the laser beams 18a, 18b can point in completely different directions, in the present exemplary embodiment exactly in 180° opposite directions.

Finally, FIG. 7 shows a further exemplary embodiment of an apparatus 20″ according to the invention, which corresponds in the view and in substantial structural elements approximately to the apparatus according to FIG. 6. However, the apparatus as a whole is not configured or arranged substantially mirror-symmetrically. Instead, the pipe base bodies 11 in this exemplary embodiment—merely by way of example—are arranged not side by side but, for example, one above the other.

A further feature that is deemed disclosed independently thereof is that the holders, not shown, for the pipe base bodies 11 are associated with a common holding device 32 or are provided thereby.

This figure is intended in particular to illustrate the idea of possible synergy effects of the invention: While, as shown in FIG. 3 or FIG. 6, completely separate band feeds were provided for the two pipe base bodies 11a and 11b, in the present exemplary embodiment a robotic arm 30 serves both pipe base bodies 11 jointly by, for example, guiding both bands 13a and 13b.

The corresponding guide members 29a and 29b can be arranged rigidly or fixedly relative to one another or can also be movable independently of one another.

This figure also shows that the bands 13a, 13b come from a common band supply 23, which here is in the form, purely by way of example, of a drum, coil or roll, but can of course also be in the form of a reel or the like.

In addition to the fundamental idea of the invention of providing only one laser source Q and thus producing certain synergy effects, further synergy effects can be achieved in particular via the feed device(s) shown.

1-10. (canceled)

11. A method for producing ribbed pipes, comprising the steps of:
ribbing and outer side of a first pipe base body with a first band, including securing the first band to the first pipe base body using a first laser beam;
and, while the first band is being secured to the first pipe base body using the first laser beam, ribbing and outer side of a second pipe base body with a second band, including securing the second band to the second pipe base body using a second laser beam, wherein the first and second laser beams come from a common laser source.

12. The method according to claim 11, including helically ribbing the base bodies.

13. The method according to claim 11, including displacing or driving the pipe base bodies relative to the laser source and/or the laser beams.

14. The method according to claim 13, including displacing or driving the pipe base bodies linearly and/or substantially at a common speed.

15. The method according to claim 13, including stopping the pipe base bodies independently of one another to change band material.

16. The method according to claim 11, including arranging outlets for the two laser beams and/or the laser source substantially between the pipe base bodies.

17. The method according to claim 16, including arranging the outlets between holders associated with the pipe base bodies.

18. The method according to claim 11, including supplying the bands to the respective pipe base body using in each case a guide element, and securing the respective bands to the respective pipe base body.

19. An apparatus for producing ribbed pipes, comprising: a laser source; and a first laser outlet associated with the laser source so as to provide a first laser beam for securing a first band to a first pipe base body; and a second laser outlet associated with the laser source so as to provide a second laser beam for securing a second band to a second pipe base body.

20. The apparatus according to claim 19, further comprising a first holder for the first pipe base body and a second holder for the second pipe base body.

21. The apparatus according to claim 20, wherein the holders are configured as conveying devices.

22. The apparatus according to claim 20, wherein the first laser outlet is associated with the first holder and the second laser outlet is associated with the second holder so that the first laser outlet is directed at the first holder and the second laser outlet is directed at the second holder.

23. The apparatus according to claim 20, further comprising flexible lines that connect the two laser outlets to the laser source via flexible lines.

24. The apparatus according to claim 23, wherein the flexible lines are light waveguides.

25. The apparatus according to claim 24, wherein the light waveguides are glass fiber cables.

26. The apparatus according to claim 19, wherein the laser source has a power of at least 2 KW.

27. The apparatus according to claim 26, wherein the laser source has a power of at least 3.5 KW.

28. The apparatus according to claim 27, wherein the laser source has a power of at least 4 KW.
